(19) United States
(12) Patent Application Publication
(10) Pub. No.: US 2021/0094363 A1
(43) Pub. Date: Apr. 1, 2021

(54) SIDEWALL CONSTRUCTION FOR A TIRE

(71) Applicant: The Goodyear Tire & Rubber Company, Akron, OH (US)

(72) Inventors: Gilles Reichling, Vichten (LU); Richard Mbewo Samwayera Fosam, Moesdorf (LU); Hendrikus Lambertus Johannes Maria de Wit, Diekirch (LU); Markus Erich Radics, Huenfeld (DE); Ganesh Viswanathan, Boevange-Sur-Attert (LU); Rene-Pierre Froissard, Givry (BE)

(21) Appl. No.: 16/587,091

(22) Filed: Sep. 30, 2019

(51) Int. Cl. B60C 15/06; B29D 30/48

(52) U.S. Cl. CPC B60C 15/0607; B60C 15/0632; B29D 2030/486; B60C 2015/0614; B29D 2030/481; B29D 30/48

(57) ABSTRACT

A bead portion of a tire includes a bead core, a first bead filler arranged at a radially outer side of the bead core, a first carcass extending around the bead core and the first bead filler, a second carcass extending radially inward and adjacent the first carcass, a second bead filler disposed axially adjacent the second carcass, a first chafer disposed at an axially outer side of the second bead filler, a second chafer extended about a radially inner end of the first carcass, and a flipper extending radially inward from a position axially adjacent an axially outer side of the first bead filler. The flipper further extends axially inward adjacent a radially inner side of the bead core. The flipper further extends radially outward to position axially adjacent a first part of the first carcass, a second part of the first carcass, the second carcass, and a radially outermost end of the first bead filler.

### FIELD OF THE INVENTION

The present invention relates to a tire provided with a unique sidewall/bead construction.

### BACKGROUND OF THE INVENTION

A factor for reducing the endurance of a bead unit includes delamination (separation) between a carcass and a rubber member contacting the outer side in the tread width direction of the carcass. One factor causing the separation may be stress generated by upthrust from a rim. Due to this stress, shear strain may cause delamination between the carcass and the bead.

In recent years, with an increased awareness for environmental concerns, the reduction of the tire weight has been desired. By reducing the tire weight, it may be possible to reduce rolling resistance, resulting in the reduction of fuel consumption. A tire with the aforementioned structure may increase tire weight. By shortening a bead filler as compared with a standard bead filler, reduction of the bead weight may still be possible. In a tire with a shortened bead filler, since stress generated by curvature and deformation of a side wall portion acts toward the vicinity of a front end portion of the shortened bead filler, separation may occur near the front end portion of the bead filler. In this regard, another reinforcing member, or flipper, may be provided at the outer side in the tire radial direction of the bead core and bead filler.

### SUMMARY OF THE INVENTION

A bead portion of a tire in accordance with the present invention includes a bead core, a first bead filler arranged at a radially outer side of the bead core, a first carcass extending around the bead core and the first bead filler, a second carcass extending radially inward and adjacent the first carcass, a second bead filler disposed axially adjacent the second carcass, a first chafer disposed at an axially outer side of the second bead filler, a second chafer extended about a radially inner end of the first carcass, and a flipper extending radially inward from a position axially adjacent an axially outer side of the first bead filler. The flipper further extends axially inward adjacent a radially inner side of the bead core. The flipper further extends radially outward to position axially adjacent a first part of the first carcass, a second part of the first carcass, the second carcass, and a radially outermost end of the first bead filler. The first carcass extends radially inward adjacent an axially inner side of the bead core, axially outward adjacent a radially inner side of the bead core, and radially outward adjacent an axially outer side of the bead core.

According to another aspect of the bead portion, the flipper extends radially outward beyond the radially outermost end of the first bead filler.

According to still another aspect of the bead portion, the second bead filler extends axially between the second carcass and the first chafer.

According to yet another aspect of the bead portion, a toe guard extends between the first chafer and the second chafer.

According to still another aspect of the bead portion, the toe guard extends between the first carcass and the second carcass.

A method in accordance with the present invention stiffens a bead portion of a tire. The method includes the steps of: arranging a first bead filler at a radially outer side of a bead core; extending a first carcass around the bead core and the first bead filler; extending the first carcass radially inward adjacent an axially inner side of the bead core; extending the first carcass axially outward adjacent a radially inner side of the bead core; extending the first carcass radially outward adjacent an axially outer side of the bead core; extending a second carcass radially inward and adjacent the first carcass; arranging a second bead filler axially adjacent the second carcass; arranging a first chafer at an axially outer side of the second bead filler; extending a second chafer about a radially inner end of the first carcass; extending a flipper radially inward from a position axially adjacent an axially outer side of the first bead filler; extending the flipper axially inward adjacent a radially inner side of the bead core; and extending the flipper radially outward to position axially adjacent a first part of the first carcass, a second part of the first carcass, the second carcass, and a radially outermost end of the first bead filler.

According to another aspect of the method, another step includes terminating a radially innermost end of the second carcass axially between the first carcass and a toe guard.

According to still another aspect of the method, another step includes extending the flipper radially outward beyond the radially outermost end of the first bead filler.

According to yet another aspect of the method, another step includes extending the second bead filler axially between the second carcass and the first chafer.

According to yet another aspect of the method, other steps include extending a toe guard between the first chafer and the second chafer; and extending the toe guard between the first carcass and the second carcass.

### DEFINITIONS

As used herein and in the claims:

“Apex” means an elastomeric filler located radially above the bead core and between the plies and the turnup ply.

“Annular” means formed like a ring.

“Aspect ratio” means the ratio of a tire section height to its section width.

“Aspect ratio of a bead cross-section” means the ratio of a bead section height to its section width.

“Asymmetric tread” means a tread that has a tread pattern not symmetrical about the centerplane or equatorial plane (EP) of the tire.

“Axial” and “axially”, or “in a tread width direction”, refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane (EP) of the tire. The belt structure may also include plies of parallel cords inclined at relatively low angles, acting as restricting layers.

“Bias tire” (cross ply) means a tire in which the reinforcing cords in the carcass ply extend diagonally across the tire from bead to bead at about a 25° to 65° angle with respect to equatorial plane (EP) of the tire. If multiple plies are present, the ply cords run at opposite angles in alternating layers.

“Breakers” means at least two annular layers or plies of parallel reinforcement cords having the same angle with reference to the equatorial plane (EP) of the tire as the parallel reinforcing cords in carcass plies. Breakers are usually associated with bias tires.

“Cable” means a cord formed by twisting together two or more plied yarns.

“Carcass” means the tire structure apart from the belt structure, tread, undertread, and sidewall rubber over the plies, but including the beads.

“Casing” means the carcass, belt structure, beads, sidewalls, and all other components of the tire excepting the tread and undertread, i.e., the whole tire.

“Chipper” refers to a narrow band of fabric or steel cords located in the bead area whose function is to reinforce the bead area and stabilize the radially inwardmost part of the sidewall.

“Circumferential” and “circumferentially” mean lines or directions extending along the perimeter of the surface of the annular tire parallel to the equatorial plane (EP) and perpendicular to the axial direction; it can also refer to the direction of the sets of adjacent circular curves whose radii define the axial curvature of the tread, as viewed in cross section.

“Cord” means one of the reinforcement strands of which the reinforcement structures of the tire are comprised.

“Cord angle” means the acute angle, left or right in a plan view of the tire, formed by a cord with respect to the equatorial plane (EP). The “cord angle” is measured in a cured but uninflated tire.

“Crown” means that portion of the tire within the width limits of the tire tread.

“Denier” means the weight in grams per 9000 meters (unit for expressing linear density). “Dtex” means the weight in grams per 10,000 meters.

“Density” means weight per unit length.

“Elastomer” means a resilient material capable of recovering size and shape after deformation.

“Equatorial plane (EP)” means the plane perpendicular to the tire's axis of rotation and passing through the center of its tread; or the plane containing the circumferential centerline of the tread.

“Evolving tread pattern” means a tread pattern, the running surface of which, which is intended to be in contact with the road, evolves with the wear of the tread resulting from the travel of the tire against a road surface, the evolution being predetermined at the time of designing the tire, so as to obtain adhesion and road handling performances which remain substantially unchanged during the entire period of use/wear of the tire, no matter the degree of wear of the tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made, that forms the basic element of filaments; characterized by having a length at least 100 times its diameter or width.

“Filament count” means the number of filaments that make up a yarn. Example: 1000 denier polyester has approximately 190 filaments.

“Flipper” refers to a reinforcing fabric around the bead wire for strength and to tie the bead wire in the tire body.

“Footprint” means the contact patch or area of contact of the tire tread with a flat surface at zero speed and under normal load and pressure.

“Gauge” refers generally to a measurement, and specifically to a thickness measurement.

“Groove” means an elongated void area in a tread that may extend circumferentially or laterally about the tread in a straight, curved, or zigzag manner. Circumferentially and laterally extending grooves sometimes have common portions. The “groove width” may be the tread surface occupied by a groove or groove portion divided by the length of such groove or groove portion; thus, the groove width may be its average width over its length. Grooves may be of varying depths in a tire. The depth of a groove may vary around the circumference of the tread, or the depth of one groove may be constant but vary from the depth of another groove in the tire. If such narrow or wide grooves are of substantially reduced depth as compared to wide circumferential grooves, which they interconnect, they may be regarded as forming “tie bars” tending to maintain a rib-like character in the tread region involved. As used herein, a groove is intended to have a width large enough to remain open in the tires contact patch or footprint.

“High tensile steel (HT)” means a carbon steel with a tensile strength of at least 3400 MPa at 0.20 mm filament diameter.

“Inner” means toward the inside of the tire and “outer” means toward its exterior.

“Innerliner” means the layer or layers of elastomer or other material that form the inside surface of a tubeless tire and that contain the inflating fluid within the tire.

“Inboard side” means the side of the tire nearest the vehicle when the tire is mounted on a wheel and the wheel is mounted on the vehicle.

“LASE” is load at specified elongation.

“Lateral” means an axial direction.

“Lay length” means the distance at which a twisted filament or strand travels to make a 360° rotation about another filament or strand.

“Load range” means load and inflation limits for a given tire used in a specific type of service as defined by tables in The Tire and Rim Association, Inc.

“Mega tensile steel (MT)” means a carbon steel with a tensile strength of at least 4500 MPa at 0.20 mm filament diameter.

“Net contact area” means the total area of ground contacting elements between defined boundary edges as measured around the entire circumference of the tread.

“Net-to-gross ratio” means the total area of ground contacting tread elements between lateral edges of the tread around the entire circumference of the tread divided by the gross area of the entire circumference of the tread between the lateral edges.

“Non-directional tread” means a tread that has no preferred direction of forward travel and is not required to be positioned on a vehicle in a specific wheel position or positions to ensure that the tread pattern is aligned with the preferred direction of travel. Conversely, a directional tread pattern has a preferred direction of travel requiring specific wheel positioning.

“Normal inner pressure” means the air pressure corresponding to the air pressure at the time of measuring tire dimensions.

“Normal load” means a maximum load (the maximum loading capability) of a single wheel in the applicable size.

“Normal rim” means a standard rim in an applicable size.

“Normal tensile steel (NT)” means a carbon steel with a tensile strength of at least 2800 MPa at 0.20 mm filament diameter.

“Outboard side” means the side of the tire farthest away from the vehicle when the tire is mounted on a wheel and the wheel is mounted on the vehicle.

“Ply” means a cord-reinforced layer of rubber-coated radially deployed or otherwise parallel cords.

“Radial” and “radially” mean directions radially toward or away from the axis of rotation of the tire.

“Radial ply structure” means the one or more carcass plies or which at least one ply has reinforcing cords oriented at an angle of between 65° and 90° with respect to the equatorial plane (EP) of the tire.

“Radial ply tire” means a belted or circumferentially-restricted pneumatic tire in which at least one ply has cords which extend from bead to bead and the ply is laid at cord angles between 65° and 90° with respect to the equatorial plane (EP) of the tire.

“Rib” means a circumferentially extending strip of rubber on the tread which is defined by at least one circumferential groove and either a second such groove or a lateral edge, the strip being laterally undivided by full-depth grooves.

“Rivet” means an open space between cords in a layer.

“Section height” means the radial distance from the nominal rim diameter to the outer diameter of the tire at its equatorial plane (EP).

“Section width” means the maximum linear distance parallel to the axis of the tire and between the exterior of its sidewalls when and after it has been inflated at normal pressure for 24 hours, but unloaded, excluding elevations of the sidewalls due to labeling, decoration, or protective bands.

“Self-supporting run-flat” means a type of tire that has a structure wherein the tire structure alone is sufficiently strong to support the vehicle load when the tire is operated in the uninflated condition for limited periods of time and limited speed. The sidewall and internal surfaces of the tire may not collapse or buckle onto themselves due to the tire structure alone (e.g., no internal structures).

“Sidewall insert” means elastomer or cord reinforcements located in the sidewall region of a tire. The insert may be an addition to the carcass reinforcing ply and outer sidewall rubber that forms the outer surface of the tire.

“Sidewall” means that portion of a tire between the tread and the bead.

“Sipe” or “incision” means small slots molded into the tread elements of the tire that subdivide the tread surface and improve traction; sipes may be designed to close when within the contact patch or footprint, as distinguished from grooves.

“Spring rate” means the stiffness of tire expressed as the slope of the load deflection curve at a given pressure.

“Stiffness ratio” means the value of a control belt structure stiffness divided by the value of another belt structure stiffness when the values are determined by a fixed three point bending test having both ends of the cord supported and flexed by a load centered between the fixed ends.

“Super tensile steel (ST)” means a carbon steel with a tensile strength of at least 3650 MPa at 0.20 mm filament diameter.

“Tenacity” is stress expressed as force per unit linear density of the unstrained specimen (gm/tex or gm/denier).

“Tensile” is stress expressed in forces/cross-sectional area. Strength in psi=12,800 times specific gravity times tenacity in grams per denier.

“Toe guard” refers to the circumferentially deployed elastomeric rim-contacting portion of the tire axially inward of each bead.

“Tread” means a molded rubber component which, when bonded to a tire casing, includes that portion of the tire that comes into contact with the road when the tire is normally inflated and under normal load.

“Tread element” or “traction element” means a rib or a block element.

“Tread width” means the arc length of the tread surface in a plane including the axis of rotation of the tire.

“Turnup end” means the portion of a carcass ply that turns upward (i.e., radially outward) from the beads about which the ply is wrapped.

“Ultra tensile steel (UT)” means a carbon steel with a tensile strength of at least 4000 MPa at 0.20 mm filament diameter.

“Vertical deflection” means the amount that a tire deflects under load.

“Yarn” is a generic term for a continuous strand of textile fibers or filaments. Yarn occurs in the following forms: (1) a number of fibers twisted together; (2) a number of filaments laid together without twist; (3) a number of filaments laid together with a degree of twist; (4) a single filament with or without twist (monofilament); and (5) a narrow strip of material with or without twist.

### BRIEF DESCRIPTION OF DRAWINGS

FIG. 1 is a schematic cross sectional view along a tire radial direction and a tread width direction of a tire in accordance with the present invention.

FIG. 2 is an enlarged cross sectional view of part of the tire of FIG. 1.

### DESCRIPTION OF EXAMPLES OF THE PRESENT INVENTION

In the following description of the drawings, the same or similar reference numerals are used to designate the same or similar parts. It may be appreciated that the drawings are schematically shown and the ratio and the like of each dimension may be different from these examples. Therefore, the specific dimensions must be determined in view of the below explanation. It is needless to say that relations and ratios among the respective dimensions may differ among the diagrams.

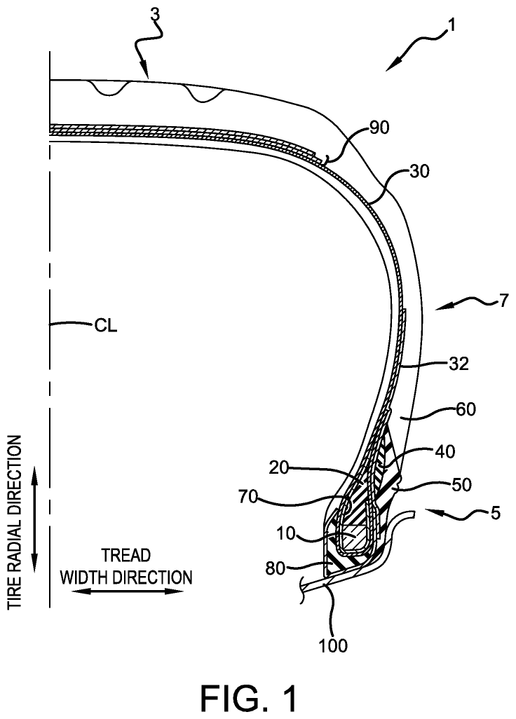

FIG. 1 shows a cross sectional view of a pneumatic or non-pneumatic tire 1 along a tire radial direction and a tread width direction of the tire in accordance with the present invention. The tire 1 may be mounted on a standard rim 100. The tire 1 may have a normal inner pressure and support a normal load. The tire 1 may include a tread portion 3, a bead portion 5, and a side wall portion 7. The tread portion 3 may contact a road surface (not shown).

The tire 1 may further include two bead portions 5 (one shown), a first carcass 30, a second carcass 32, a side rubber layer 60, and a belt portion 90. The first carcass 30 may be arranged throughout the tread portion 3, the bead portion 5, and the side wall portion 7. The first carcass 30 may extend between a pair of the bead cores 10 (one shown) and a pair of the first bead fillers 20 (one shown). The first carcass 30 may curve radially inward to the axially inner side of the bead cores 10 and the first bead fillers 20 and wrap around the axially outer sides of the bead cores 10.

The second carcass 32 may be arranged throughout the tread portion 3, the bead portion 5, and the side wall portion 7. The second carcass 32 may curve radially inward to the axially inner side of the bead cores 10. The second bead filler 40 may be arranged at the axially outer side of the first carcass 30 and the second carcass 32.

The example bead portion 5 may be attached to, or in contact with, the rim 100. The side wall portion 7 may interconnect the tread portion 3 and the bead portion 5. The bead portion(s) 5 may include a bead core 10, a first bead filler 20, a second bead filler 40, a first chafer 50, a reinforcing layer 70, a second chafer 80, and a toe guard 91.

The bead core 10 may allow the attachment of the tire 1 to the rim 100. The bead core 10 be constructed of bead wire (not shown). The first bead filler 20 may be arranged at the radially outer side of the bead core 10. The first bead filler 20 may have an approximate triangular shape.

The first chafer 50 may be arranged at the axially outer side of the bead portion 5. More specifically, the first chafer 50 may be arranged at the axially outer side the second carcass 32 and the second bead filler 40. A side rubber layer 60 of the side wall portion 7 may be arranged at the axially outer side of the first carcass 30 and the second carcass 32. A second chafer 80 may extend axially between the first carcass 30 and the second carcass 32. The second chafer 80 may prevent toe chipping at the rim 100. A belt layer 90 may be arranged in the tread portion 3 at the axially outer side of the first carcass 30. The belt layer 90 may include, for example, two belts.

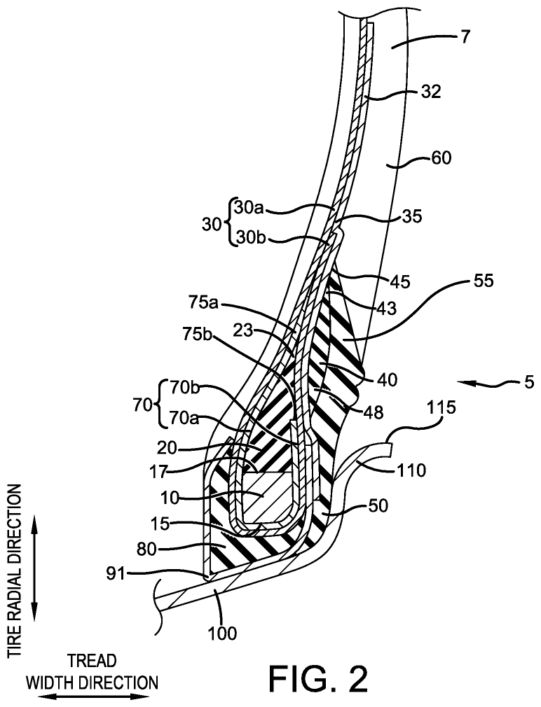

As shown in FIG. 2, the bead portion 5 may include the bead core 10, the first bead filler 20, the first carcass 30, the second carcass 32, the second bead filler 40, the rubber chafer 50, the reinforcing layer 70, and the second chafer 80. The bead core 10 may have a bead core-innermost surface 15 which is an innermost surface of the bead core 10 in the tire radial direction. Further, the bead core 10 may have a bead core-outermost surface 17 which is an outermost surface of the bead core 10 in the tire radial direction.

The first bead filler 20 may have a first bead filler outer end portion 23 which is an outer end portion in the tire radial direction of the first bead filler 20. As illustrated in FIG. 2, the thickness of the first bead filler outer end portion 23 may be reduced toward the outer side in the tire radial direction, that is, the first bead filler outer end portion, which is an outermost end of the first bead filler 20 in the tire radial direction. An inner end portion in the tire radial direction of the first bead filler 20 may contact the bead core 10.

The first carcass 30 may have an inner first carcass 30a positioned at the inner side in the tread width direction and an outer first carcass 30b curved to the outer side in the tread width direction. The outer first carcass 30b may be positioned at the outer side in the tread width direction from the inner carcass 30a. An outer carcass outer front end 35, which is an outermost end in the tire radial direction of the outer carcass 30b, may contact the inner carcass 30a. Between the inner first carcass 30a and the outer first carcass 30b, the bead core 10 and the first bead filler 20 may be arranged.

The second carcass 32 may be arranged at the outer side in the tread width direction of the outer first carcass 30b while contacting the outer first carcass 30b. An outer end portion in the tire radial direction of the second carcass 32 may be positioned proximate/adjacent the side wall portion 7.

The second bead filler 40 may be positioned at the outer side in the tread width direction from the outer first carcass 30b. The second bead filler 40 may have a second bead filler outer end portion 43, which is an outer end portion in the tire radial direction, and a second bead filler inner end portion 48, which is an inner end portion in the tire radial direction. As illustrated in FIG. 2, the thickness of the second bead filler 40 may be reduced toward the end portion of the second bead filler 40 in the tire radial direction from the center of the second bead filler 40 in the tire radial direction. That is, the thicknesses of the second bead filler outer end portion 43 and the second bead filler inner end portion 48 may be thinner than that of the center of the second bead filler 40.

The second bead filler 40 may extend both axially and radially beyond the first bead filler outer end portion 23 in the tread width direction. Accordingly, the second bead filler 40 overlaps the first bead filler outer end portion 23 in the tread width direction. An outermost end of the second bead filler outer end portion 43 in the tire radial direction may be positioned at the outer side in the tire radial direction radially outward from the first bead filler outer front end 23. The second bead filler inner end portion 48 may be positioned at a radially outer side of the bead core 10. Accordingly, the second bead filler inner end portion 48 may be positioned at the outer side in the tire radial direction from the bead core-outermost surface 17. The second bead filler 40 may contact the second carcass 32 at the inner side in the tread width direction. The second bead filler 40 may contact the rubber chafer 50 at the outer side in the tread width direction.

The rubber chafer 50 may be arranged at the outer side in the tread width direction of the second bead filler 40. The rubber chafer 50 may be exposed at the outer side in the tread width direction of the overall bead unit 5. A rim line 150 may be formed at an exposed portion of the rubber chafer 50. The rubber chafer 50 may have a rubber chafer outer end portion 55 which is an outer end portion in the tire radial direction. The rubber chafer outer end portion 55 may have different heights in the tire radial direction at the inner side in the tread width direction and the outer side in the tread width direction. At the rubber chafer outer end portion 55, a rubber chafer width direction-inner end may be positioned at the inner side in the tread width direction and may have a height in the tire radial direction, which is higher than that of a rubber chafer width direction-outer end positioned at the outer side in the tread width direction. That is, the rubber chafer width direction-outer end may be so positioned at the inner side in the tire radial direction from the rubber chafer width direction-inner end. The rubber chafer outer end portion 55 may approach the inner side in the tire radial direction as it extends toward the outer side in the tread width direction.

In the tread width direction, the rubber chafer 50 may extend outward of the second bead filler 40. Accordingly, the rubber chafer outer end portion 55 may be positioned at the outer side in the tread width direction from the second bead filler outer end portion 43. More specifically, the rubber chafer width direction-inner end may be positioned at the outer side in the tread width direction from the second bead filler outer end portion 43. The inner end portion of the rubber chafer 50 in the tire radial direction may contact the rim 100 at a rim flange 110. The rubber chafer 50 may be constructed of a rubber-like member with a density lower than that of the second bead filler 40. Further, the loss tangent of the second bead filler 40 may be smaller than that of the rubber chafer 50. The side rubber layer 60 may contact the second carcass 32 at the inner side in the tread width direction. The side rubber layer 60 may contact the rubber chafer outer end portion 55 at the inner side in the tire radial direction.

In accordance with the present invention, the reinforcing layer 70 may wrap around the bead core 10 and extend radially outward from the radially inner side of the bead core 10. In the tread width direction, the reinforcing layer 70 may have an axially inner layer 70a positioned at the inner side of the bead core 10 and an axially outer layer 70b positioned at the outer side of the bead core. A radially outer end 75a of the axially inner layer 70a may extend radially outward to a position axially adjacent the inner first carcass 30a, the outer first carcass 30b, the second carcass 32, and the first bead filler outer end portion 23. A radially outer end 75b of the axially outer layer 70b may extend radially outward to a position adjacent the first bead filler 20.

The reinforcing layer, or flipper 70, of the present invention may increase cornering stiffness of tire 1 thereby enhancing dynamic operating conditions, such as ride & handling performance of the tire. Further, such a flipper 70 may provide little or no negative impact to rolling resistance of the tire 1 or other factors, such as manufacturing complexity and cost.

The foregoing and other objects, features, and advantages of the present invention will be apparent from the above detailed descriptions of examples of the present invention, as illustrated in the accompanying drawings wherein like reference numbers represent like parts of the present invention. Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed:

1. A bead portion of a tire comprising:
a bead core;
a first bead filler arranged at a radially outer side of the bead core;
a first carcass extending around the bead core and the first bead filler, the first carcass extending radially inward adjacent an axially inner side of the bead core, extending axially outward adjacent a radially inner side of the bead core, and extending radially outward adjacent an axially outer side of the bead core;
a second carcass extending radially inward and adjacent the first carcass;
a second bead filler disposed axially adjacent the second carcass;
a first chafer disposed at an axially outer side of the second bead filler;
a second chafer extended about a radially inner end of the first carcass; and
a flipper extending radially inward from a position axially adjacent an axially outer side of the first bead filler, the flipper extending axially inward adjacent a radially inner side of the bead core, and the flipper extending radially outward to position axially adjacent a first part of the first carcass, a second part of the first carcass, the second carcass, and a radially outermost end of the first bead filler.

2. The bead portion as set forth in claim 1 wherein the flipper extends radially outward beyond the radially outermost end of the first bead filler.

3. The bead portion as set forth in claim 1 wherein the second bead filler extends axially between the second carcass and the first chafer.

4. The bead portion as set forth in claim 1 further including a toe guard extending between the first chafer and the second chafer.

5. The bead portion as set forth in claim 1 further including a toe guard extending between the first carcass and the second carcass.

6. A method for stiffening a bead portion of a tire, the method comprising the steps of:
arranging a first bead filler at a radially outer side of a bead core;
extending a first carcass around the bead core and the first bead filler;
extending the first carcass radially inward adjacent an axially inner side of the bead core;
extending the first carcass axially outward adjacent a radially inner side of the bead core;
extending the first carcass radially outward adjacent an axially outer side of the bead core;
extending a second carcass radially inward and adjacent the first carcass;
arranging a second bead filler axially adjacent the second carcass;
arranging a first chafer at an axially outer side of the second bead filler;
extending a second chafer about a radially inner end of the first carcass;
extending a flipper radially inward from a position axially adjacent an axially outer side of the first bead filler;
extending the flipper axially inward adjacent a radially inner side of the bead core; and
extending the flipper radially outward to position axially adjacent a first part of the first carcass, a second part of the first carcass, the second carcass, and a radially outermost end of the first bead filler.

7. The method as set forth in claim 6 further including the step of terminating a radially innermost end of the second carcass axially between the first carcass and a toe guard.

8. The method as set forth in claim 6 further including the step of extending the flipper radially outward beyond the radially outermost end of the first bead filler.

9. The method as set forth in claim 6 further including the step of extending the second bead filler axially between the second carcass and the first chafer.

10. The method as set forth in claim 6 further including the steps of:
extending a toe guard between the first chafer and the second chafer; and
extending the toe guard between the first carcass and the second carcass.
